(19) United States
(12) Patent Application Publication
(10) Pub. No.: US 2026/0103338 A1
(43) Pub. Date: Apr. 16, 2026

(54) TRASH CAN FOOTHOLD

(71) Applicant: Findlay Machine & Tool, LLC, Findlay, OH (US)

(72) Inventors: Nickolas Reinhart, Sarasota, FL (US); Joe Klein, Findlay, OH (US); Ben Sayalith, Findlay, OH (US)

(21) Appl. No.: 19/421,042

(22) Filed: Dec. 16, 2025

Related U.S. Application Data
(63) Continuation-in-part of application No. 19/280,723, filed on Jul. 25, 2025.
(63) Continuation of application No. 29/941,385, filed on May 9, 2024.
(63) Continuation of application No. 29/941,373, filed on May 9, 2024.
(63) Continuation of application No. 29/941,381, filed on May 9, 2024.
(63) Continuation of application No. 29/941,334, filed on May 9, 2024.
(63) Continuation of application No. 29/941,337, filed on May 9, 2024.
(63) Continuation of application No. 29/941,339, filed on May 9, 2024.
(63) Continuation of application No. 29/941,367, filed on May 9, 2024.
(63) Continuation of application No. 29/941,365, filed on May 9, 2024.
(63) Continuation of application No. 29/941,371, filed on May 9, 2024.
(63) Continuation of application No. 29/941,420, filed on May 9, 2024.
(63) Continuation of application No. 29/941,410, filed on May 9, 2024.
(63) Continuation of application No. 29/941,432, filed on May 9, 2024.
(63) Continuation of application No. 29/941,445, filed on May 9, 2024.
(63) Continuation of application No. 29/941,386, filed on May 9, 2024.
(63) Continuation of application No. 29/941,453, filed on May 9, 2024.
(63) Continuation of application No. 29/940,275, filed on May 1, 2024.
(63) Continuation of application No. 29/940,294, filed on May 1, 2024.
(63) Continuation of application No. 29/940,295, filed on May 1, 2024.
(63) Continuation of application No. 29/940,254, filed on May 1, 2024, now Pat. No. D1097418.
(63) Continuation of application No. 29/940,268, filed on May 1, 2024, now Pat. No. D1097431.
(63) Continuation of application No. 29/940,328, filed on May 1, 2024.
(63) Continuation of application No. 29/940,317, filed on May 1, 2024.
(63) Continuation of application No. 29/940,309, filed on May 1, 2024.
(63) Continuation of application No. 29/940,306, filed on May 1, 2024.
(63) Continuation of application No. 29/940,314, filed on May 1, 2024.
(60) Provisional application No. 63/675,562, filed on Jul. 25, 2024.

(51) Int. Cl. B65F 1/14; B65F 1/02

(52) U.S. Cl. CPC B65F 1/14; B65F 1/02

(57) ABSTRACT

A receptacle is provided. The receptacle includes a hollow body having a bottom panel and sidewall extending upwardly to a rim, with a lift handle formed on the sidewall. Vertical recessed portions are formed in the sidewall extending from adjacent the rim to the bottom panel, with hand grips disposed within the vertical recessed portions below the lift handle at junctions where the bottom panel and sidewall meet. Each hand grip includes a grip recess defined by grip side walls, rear grip wall, and top wall, with grip elements positioned between the grip side walls. A stabilization foothold is disposed centrally on the bottom panel circumference between the hand grips, including a foothold recess with sloped edges located at junctions where a foothold bottom wall meets foothold side walls.

### CROSS-REFERENCE TO RELATED APPLICATIONS

This application is a continuation-in-part of U.S. application No. Ser. No. 19/280,723, filed on Jul. 25, 2025, which claims the benefit of U.S. Provisional Application No. 63/675,562, filed on Jul. 25, 2024. This application also incorporates by reference the following U.S. Design Applications: U.S. Design application Ser. Nos. 29/940,254, 29/940,268, 29/940,275, 29/940,294, 29/940,295, 29/940,328, 29/940,317, 29/940,309, 29/940,306, and 29/940,314, each filed on May 1, 2024; and U.S. Design Application Ser. Nos. 29/941,453, 29/941,337, 29/941,339, 29/941,334, 29/941,367, 29/941,365, 29/941,371, 29/941,385, 29/941,373, 29/941,381, 29/941,420, 29/941,410, 29/941,432, 29/941,445, and 29/941,386, each filed on May 9, 2024. The entire disclosures of the above applications are incorporated herein by reference.

### FIELD

The present technology relates to receptacles and, more particularly, to structural enhancements of lift handles for receptacles.

### INTRODUCTION

This section provides background information related to the present disclosure which is not necessarily prior art.

Receptacles can be used to store and transport a variety of objects and can include one or more lift handles to facilitate lifting and moving the receptacle. Trash cans, a common intended use of such receptacles, are used for waste management in both residential and commercial settings and are frequently equipped with one or more lift handles to facilitate the movement and handling of the trash can, especially when it is full. However, the lift handles on certain trash cans can be prone to structural failure due to various stresses imposed during use. Issues include bending, deforming, and cracking of the lift handle, which can limit the functionality and lifespan of the trash can.

Design and material selection of the lift handles can influence their durability and usability. In certain trash cans, the handles are either integrated into a body of the trash can or attached in a manner that does not sufficiently distribute a load borne by the trash can. This can result in excessive stress at one or more attachment points and along the handle itself, leading to premature wear and cracking, including the detachment of the lift handle from the receptacle. Such failures can limit use of the trash can and in certain instances necessitate the replacement of the trash can.

Ergonomics of the lift handles is frequently overlooked in the design of certain trash cans. Lift handles that are not ergonomically designed can cause discomfort to a user, and can even limit use of the lift handle for the user, particularly when lifting heavy loads. The lack of ergonomic considerations can deter proper use and ultimately reduce the effectiveness of waste management practices.

Environmental factors such as exposure to various weather conditions and chemicals can also contribute to degradation of the lift handles. Materials used in some existing trash can handles may not be adequately resistant to such factors, leading to accelerated wear and failure. This issue is particularly pronounced in outdoor settings where trash cans can be exposed to a wide range of environmental stressors.

Beyond the structural challenges of lift handles, receptacles present additional operational limitations that affect user efficiency during routine handling tasks. Footholds can facilitate the removal of liners and other items from receptacles by providing ground stabilization that allows users to apply controlled extraction forces without compromising receptacle stability. However, conventional foothold designs often lack adequate structural reinforcement to withstand repeated engagement during these operations, particularly when removing compacted debris or materials that have adhered to receptacle walls. The absence of proper load distribution in foothold structures can result in stress concentration points that lead to cracking and structural failure, limiting the operational reliability of these stabilization features.

Similarly, bottom lift handles can facilitate lifting and rotating operations required for controlled dumping or pouring of receptacle contents, providing optimal leverage points for these dynamic loading conditions. Conventional bottom handle designs, however, frequently lack the dimensional optimization and structural integration necessary to maintain receptacle stability during rotational movements. The positioning and sizing of these handles can compromise the structural integrity of the receptacle's bottom panel, creating weak points that reduce the overall durability of the container system. Additionally, the lack of coordination between upper lift handles and lower operational controls can result in awkward handling scenarios that increase physical strain and reduce operational efficiency during waste management procedures.

Accordingly, there is a continuing need for an improved design of lift handles for receptacles, including trash cans, that addresses the aforementioned issues. Desirably, such a design would enhance the structural integrity and durability of the lift handle, distribute loads more effectively, and incorporate ergonomic features to improve user comfort and ease of use. This would extend the service life of the receptacle, reduce the need for frequent replacements, and promote more efficient waste management practices.

### SUMMARY

In concordance with the instant disclosure, an improved design of a lift handle for a trash can has surprisingly been discovered. The present technology includes articles of manufacture, systems, and processes that relate to the structural reinforcement and ergonomic optimization of a lift handle for a trash can to enhance durability, user comfort, and overall functionality.

In one embodiment, a receptacle is provided. The receptacle may include a hollow body having a bottom panel and a sidewall extending upwardly from the bottom panel and terminating at a rim defining an open end. A lift handle may be formed on the sidewall to provide the enhanced durability and load distribution characteristics established in the parent application. The receptacle may include vertical recessed portions formed in the sidewall and extending from adjacent the rim to the bottom panel, creating structural channels that align with the lift handle components. Hand grips may be disposed within the vertical recessed portions below the lift handle at junctions where the bottom panel and sidewall meet, providing supplementary manual engagement points that work in conjunction with the existing lift handle system to create comprehensive operational control throughout the receptacle height.

In another embodiment, a receptacle is provided. The receptacle may include a hollow body having a bottom panel and a sidewall extending upwardly from the bottom panel to provide the basic container structure. A stabilization foothold may be disposed on a circumference of the bottom panel, positioned to work in conjunction with hand grips to create a triangulated stability system. The foothold may include a foothold recess that projects into the hollow body, with the foothold recess defined by foothold side walls, a rear foothold wall, and a foothold bottom wall having sloped edges located at junctions where the foothold bottom wall meets the foothold side walls. The sloped edges may create increased structural thickness at critical load-bearing zones while a reinforcing grid structure integrated into the foothold bottom wall may provide variable density reinforcement that optimizes material distribution and extends the structural enhancement principles established throughout the receptacle design.

### DRAWINGS

The drawings described herein are for illustrative purposes only of selected embodiments and not all possible implementations, and are not intended to limit the scope of the present disclosure.

FIG. 1 is a perspective view of a receptacle having a lift handle according to an embodiment of the present disclosure.

FIG. 2 is an enlarged top perspective view of the lift handle shown in FIG. 1.

FIG. 3 is an enlarged bottom perspective view of the lift handle shown in FIG. 1.

FIG. 4 is a cross-sectional view of the lift handle shown in FIG. 2 taken along section line 4-4.

FIG. 5 is a is a front elevational view thereof.

FIG. 6 is a left-side elevational view thereof.

FIG. 7 is a top plan view thereof.

FIG. 8 is a bottom plan view thereof.

FIG. 9 is a bottom perspective view of the receptacle.

FIG. 10 is a side elevational view thereof.

FIG. 11 is a bottom plan view thereof.

FIG. 12 is a cross sectional, side elevational view thereof.

FIG. 13 is a flowchart illustrating a method of manufacturing the lift handle for a receptacle, according to another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the structural integrity and ergonomic design of lift handles on receptacles. It should be understood that the lift handles can be used with or integrated into various types of receptacles including trash cans. The term “trash can” simply refers to a common intended use of such receptacles, however, the receptable can be used for many other purposes and functions. By addressing the common issues of bending, deforming, and cracking that plague conventional receptacle handles, this technology enhances the durability and usability of receptacles. Additionally, the lift handle incorporates ergonomic features that reduce the risk of discomfort or injury when using the receptacle. This can not only extend the service life of the trash cans but also promotes more effective and user-friendly receptacle handling solutions.

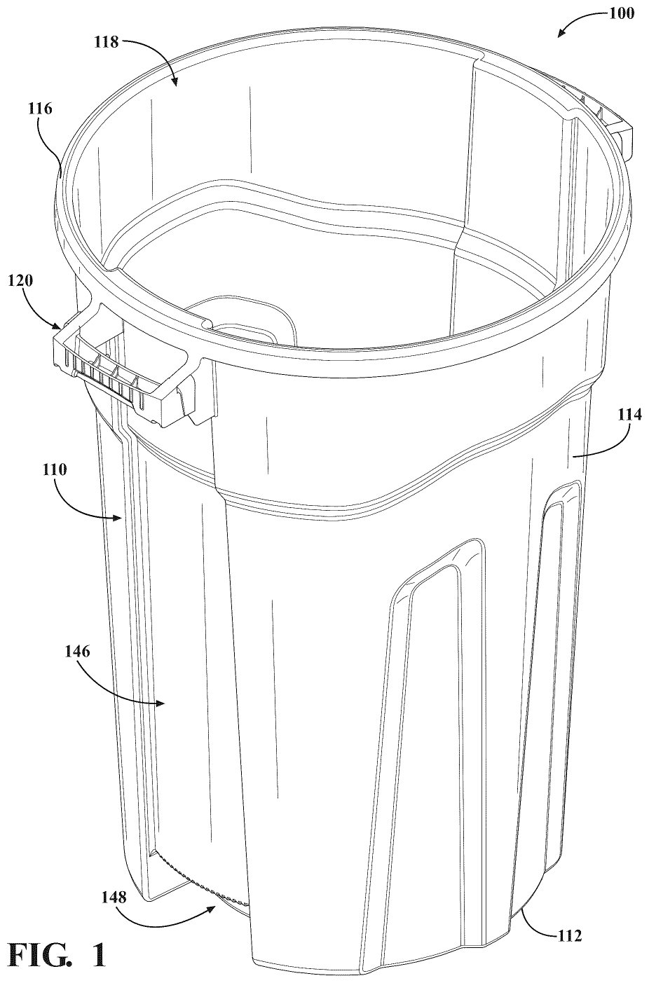

With reference now to FIG. 1, an embodiment of a receptacle 100 including a lift handle 120 designed to enhance user comfort and durability, is shown. In the illustrated embodiment, the lift handle 120 is shown as part of a “trash can.” It should be understood that the lift handle 120 can be used with or integrated into various types of receptacles, including trash cans. The term “trash can” refers to a common intended use of such receptacles; however, the receptacle 100 can be used for many other purposes and functions and be formed to having many different shapes and configurations. The receptacle 100 includes a hollow body 110 that serves as a container for waste, debris, and/or other items. The hollow body 110 can be constructed from materials such as plastic, metal, or any suitable composite that provides durability and resistance to environmental factors. Furthermore, manufacturing process such as injection molding, 3-D printing, metal stamping and/or forming, and other suitable manufacturing process can be utilized to form the receptacle 100.

The hollow body 110 of the receptacle 100 can include a bottom panel 112 and a sidewall 114. The bottom panel 112 can form the base of the receptacle 100, supporting the contents within. The sidewall 114 can extend upwardly from the periphery of the bottom panel 112 and terminate at a rim 116, which defines an open end 118 of the receptacle 100. The sidewall 114 can be configured in various shapes and cross-sections, and can include various additional features to enhance aspects of the receptacle 100, including rigidity, stability, stacking with other receptacles 100, and the use thereof. One or more lift handles 120 can be formed on the sidewall 114 of the receptacle 100. The lift handle 120 can facilitate the manual handling of the receptacle 100, making it easier to lift, move, or empty the contents of the receptacle 100. In this way, the lift handle 120 enhances the functionality of the receptacle 100.

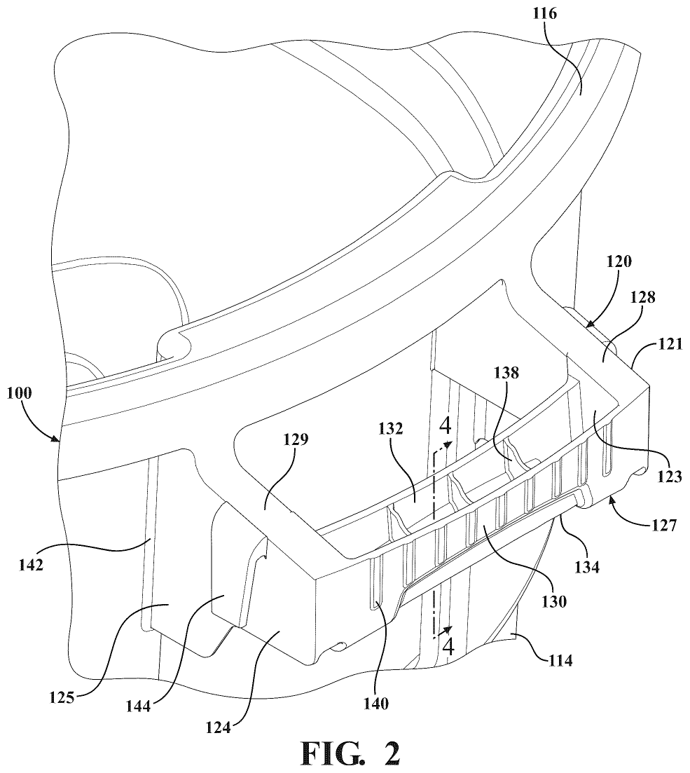

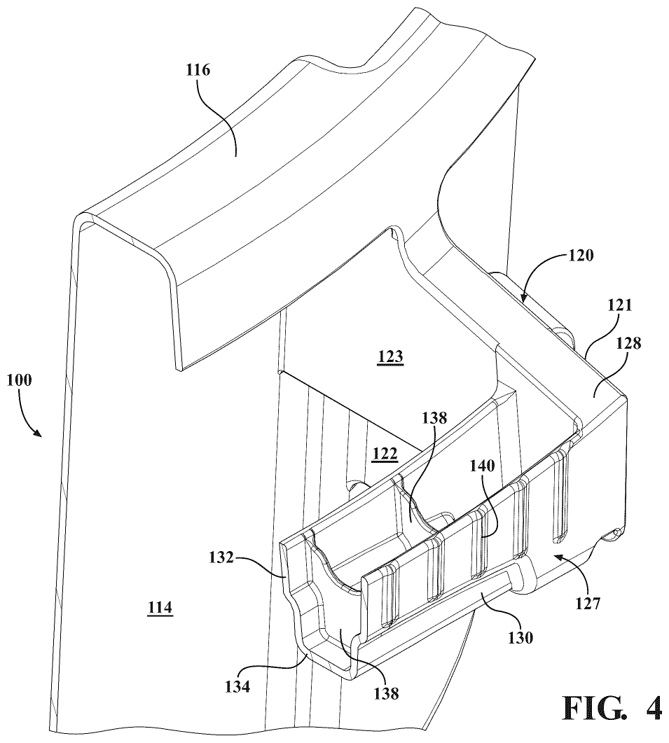

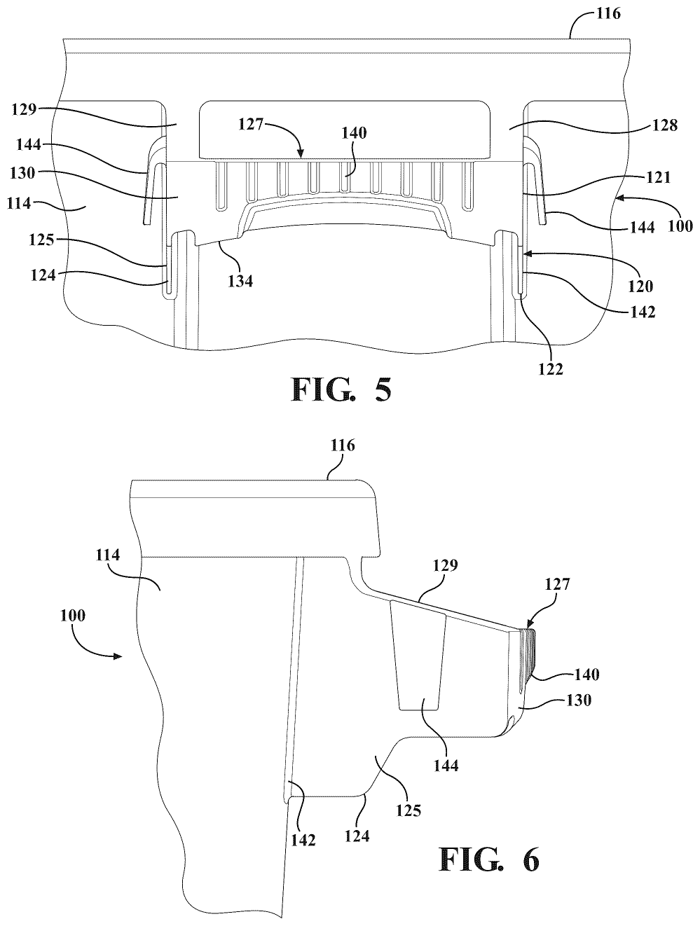

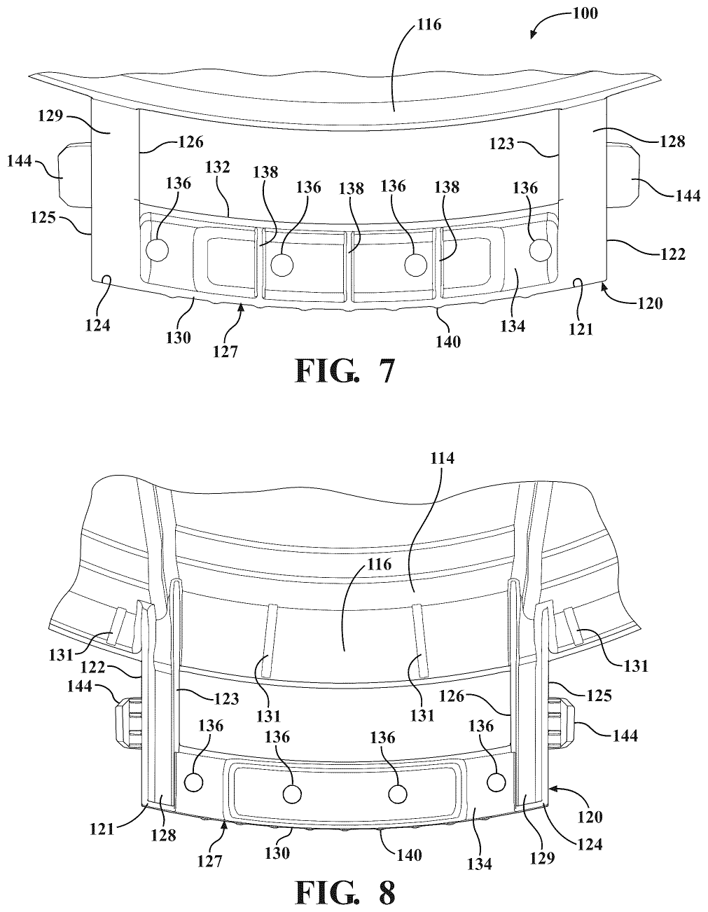

With reference to FIGS. 2-8, the lift handle 120 can include various aspects. The lift handle 120 can include a first side support 121 and a second side support 124 spaced apart from the first side support 121. The side supports 121, 124 can extend outwardly from the sidewall 114. The first side support 121 of the lift handle 120 can include a first outer wall 122 and a first inner wall 123, the first outer wall 122 and the first inner wall 123 extending outwardly from the sidewall 114 of the receptacle 100. The second side support 124 of the lift handle 120 can include a second outer wall 125 and a second inner wall 126, the second outer wall 125 and the second inner wall 126 extending outwardly from the sidewall 114 of the receptacle 100. The outer walls 122, 125 and inner walls 123, 126 are spaced apart, creating a gap therebetween. It should be understood that gap between the outer walls 122, 125 and inner walls 123, 126 can include reinforcing materials and/or structural elements or be left open to reduce the weight of the receptacle 100.

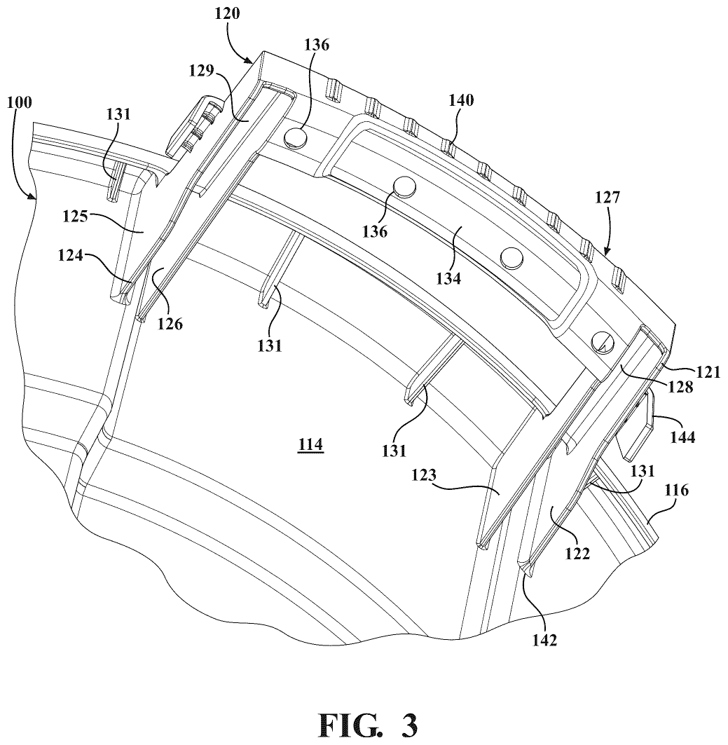

A first connecting wall 128 can be provided that joins the first outer wall 122 and the first inner wall 123 of the first side support 121, and a second connecting wall 129 can be provided that joins the second outer wall 125 and the second inner wall 126 of the second side support 124. In the illustrated embodiment, the first connecting wall 128 and the second connecting wall 129 can be join the upper ends of the respective outer walls 122, 125 and inner walls 123, 126. One or more of the outer walls 122, 125, the inner walls 123, 126, and the connecting walls 128, 129 can be coupled to the rim 116. Furthermore, as shown in FIG. 3, a rib 131 can be formed in the receptacle 100 under the rim 116 adjacent the lift handle 120 to reinforce the rim 116 and/or the lift handle 120.

The outer walls 122, 125 and inner walls 123, 126 of the side supports 121, 124 can be coupled to the sidewall 114 of the hollow body 110. A reinforcing member 142, such as a radiused transition, can be provided between the outer walls 122, 125 and inner walls 123, 126 of the side supports 121, 124 and the sidewall 114 to strengthen the coupling of the outer walls 122, 125 and inner walls 123, 126 of the side supports 121, 124 to the sidewall 114.

A hand grip 127 can be disposed between the first side support 121 and the second side support 124. The hand grip 127 can include an outer facing wall 130, an inner facing wall 132, and a bottom wall 134. The outer facing wall 130, the inner facing wall 132, and the bottom wall 134 can form a generally U-shaped cross-section of the hand grip 127, which can provide ergonomically shape designed to fit comfortably in the hand of a user. It should be understood the transition between the outer facing wall 130 and the bottom wall 134 as well as the inner facing wall 132 and the bottom wall 134 can include a radius, chamfered, angled segments, and/or recessed areas to facilitate a user to comfortably engaging the handle with a hand.

The outer facing wall 130 of the hand grip 127 may be coupled to the outer walls 122, 125 of the first and second side supports 121, 124. Additionally, the outer facing wall 130 of the hand grip 127 may be coupled to the inner walls 123, 126 of the first and second side supports 121, 124. The inner facing wall 132 and the bottom wall 134 of the hand grip 127 may be coupled to the inner walls 123, 126 of the first and second side supports 121, 124. This configuration can facilitate a distribution of a load applied to the lift handle 120 to a greater area of the sidewall 114 to minimize stress at locations where the lift handle 120 is coupled to the sidewall 114, thus enhancing the overall durability of the lift handle 120.

The bottom wall 134 of the hand grip 127 may include apertures 136. These apertures 136 may provide a path for fluids and other debris to pass through, preventing accumulation of such fluids and debris within U-shaped cavity of the hand grip 127 and helping to maintain maintaining cleanliness and hygiene. The hand grip 127 can include a rib 138 formed within the generally U-shaped cross-section cavity of the hand grip 127. The rib 138 can be coupled to at least two of the outer facing wall 130, the inner facing wall 132, and the bottom wall 134 of the hand grip 127 to reinforce and enhance the overall durability of the lift handle 120. In the illustrated embodiment three of the ribs 138 are provided; however, it should be understood that fewer or more than three of the ribs 138 can be provided to provide a desired strength to the lift handle 120 and as needed as the dimensions of the lift handle 120 are scaled up and down as may be needed or desired for receptacles of different size.

The hand grip 127 may include includes a non-slip feature 140 to enhance the grip on the user on the hand grip 127. The non-slip feature 140 can include a protrusion, a valley, a recessed area, a texture, or the like formed on a surface of the hand grip 127 configured to contact a hand of the user. It should be understood that the non-slip feature 140 can be formed on one or more of the outer facing wall 130, the inner facing wall 132, and the bottom wall 134 of the hand grip 127. Furthermore, the bottom wall 134 of the hand grip 127 can be curved to position a center portion of the bottom wall 134 closer to the rim 116 of the receptacle 100 than an end portion of the bottom wall 134 where a height of the outer facing wall 130 and the inner facing wall 132 are greater at the ends thereof as compared to the height of the center portion, the curvature of the bottom wall 134 enhancing ergonomic features of the lift handle 120.

In certain embodiments, the lift handle 120 can include a cinch 144 formed on an outer facing surface of the first outer wall 122 and the second outer wall 125 of the side supports 121, 124. In the illustrated embodiment, the cinch 144 is provided on each of the first outer wall 122 and the second outer wall 125. It should be understood that the cinch 144 can be formed on just one of the first outer wall 122 and the second outer wall 125, as desired. The cinch 144 can be provided to receive a portion of a bag and/or liner (not shown) that can be received in the hollow body 110 of the receptacle 100 where an open end of the liner can wrap the rim 116 and a portion of an upper edge of the liner can be received in the cinch 144 to facilitate maintaining the liner in a desired position with respect to the hollow body of the receptacle 100.

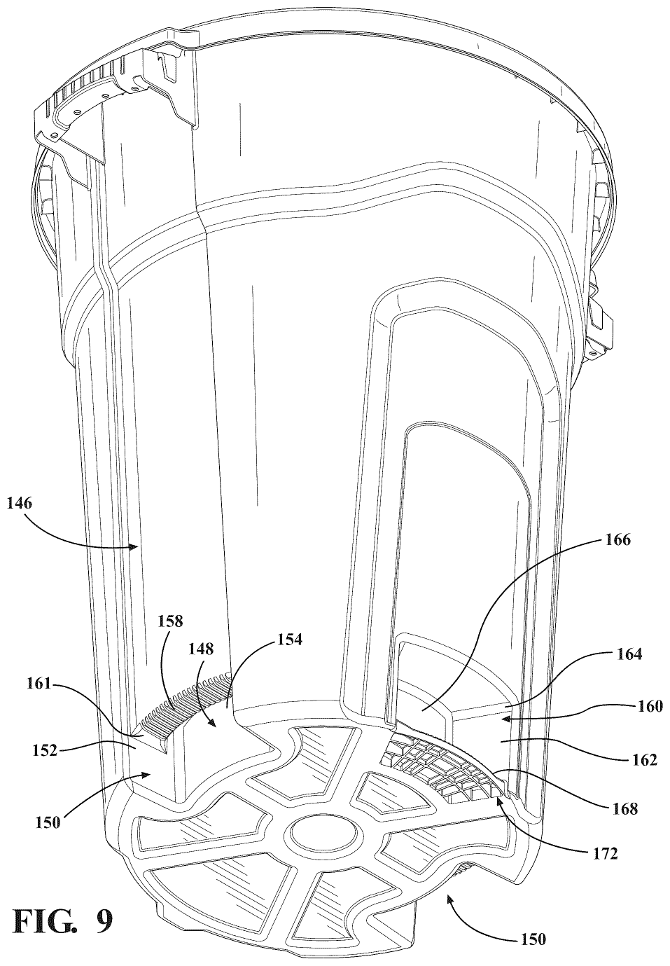

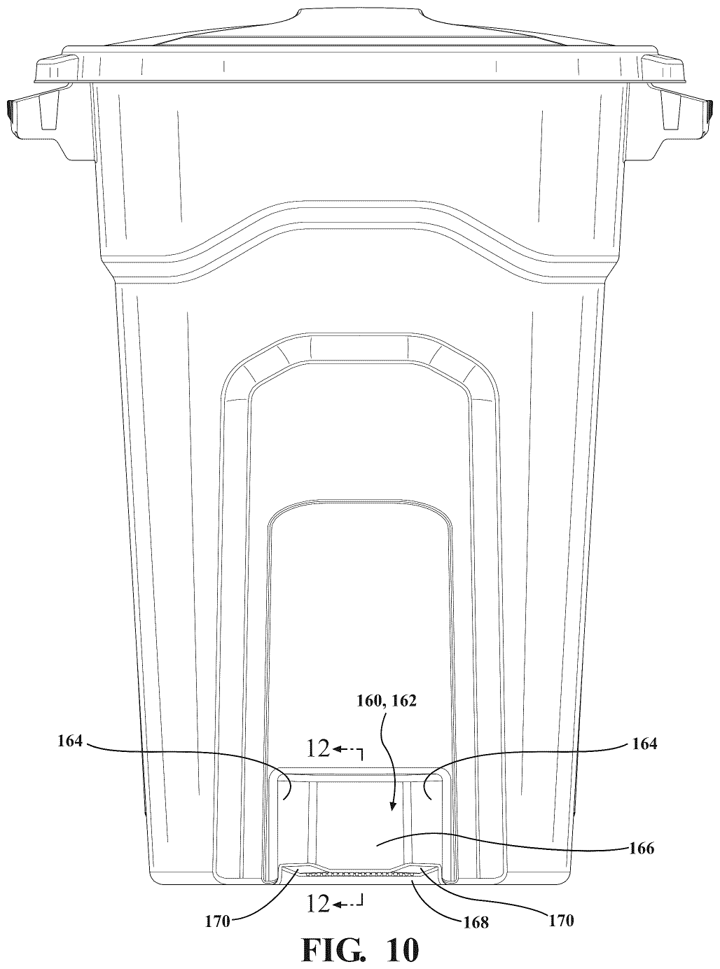

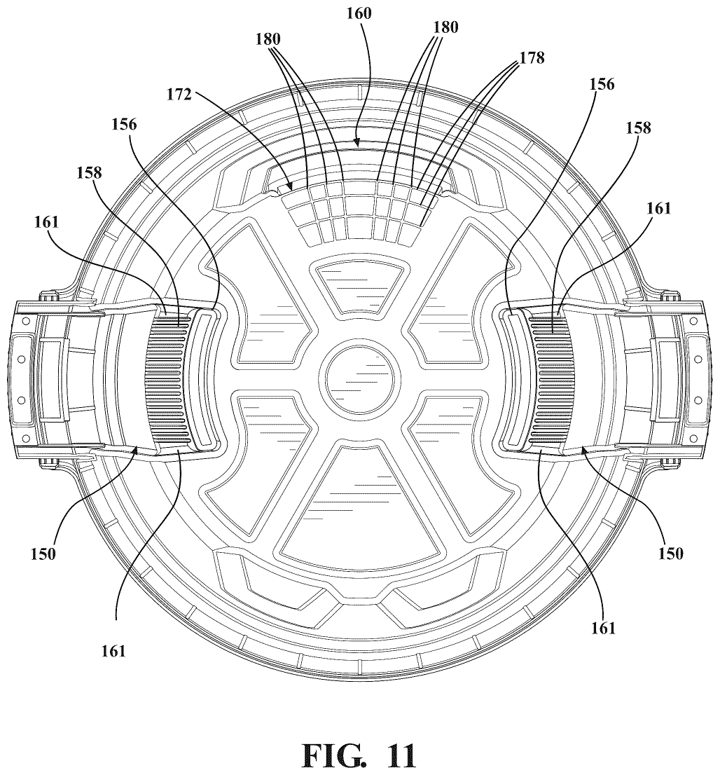

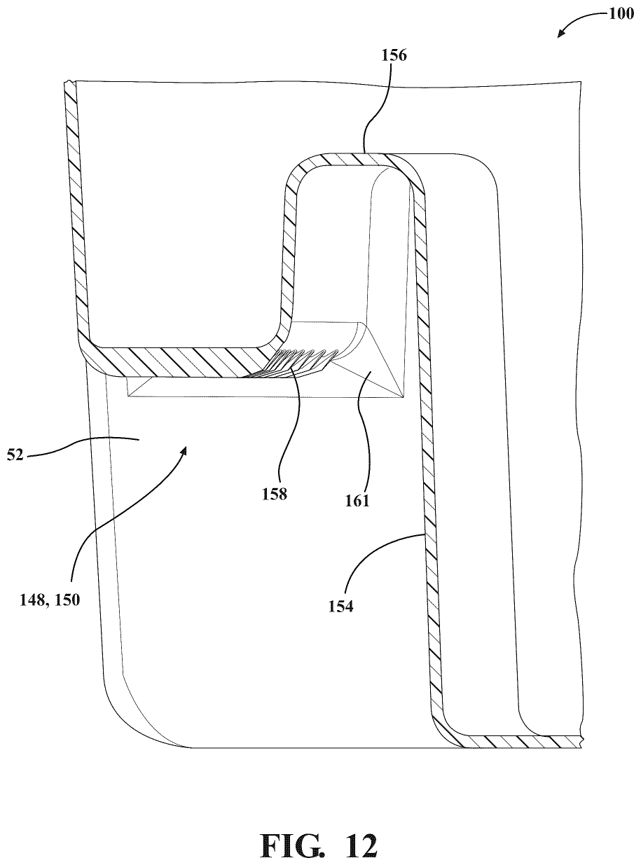

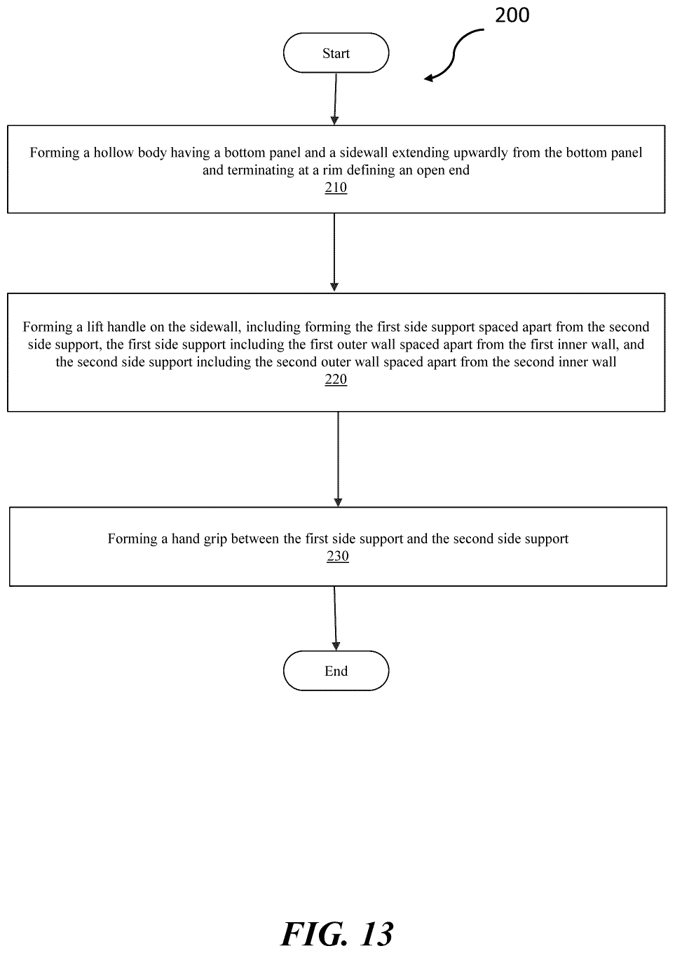

A method of manufacturing the receptacle 100 is shown in FIG. 9. The method 200 can include a step 210 of forming the hollow body 110 with the bottom panel 112 and the sidewall 114. A step 220 in the method 200 can involve forming the lift handle 120 on the sidewall 114. This step 220 can include forming the first side support 121 spaced apart from the second side support 124, the first side support 121 including the first outer wall 122 spaced apart from the first inner wall 123, and the second side support 124 including the second outer wall 125 spaced apart from the second inner wall 126. Where the lift handle 120 is integrated into the receptacle 100, such as where the receptacle 100 and associated features are formed by injection molding. It should be understood that the steps 210, 220, 230 can occur contemporaneously or substantially contemporaneously depending on the design of the mold for forming the receptacle 100.

Additional steps in the method 200 can include forming the hand grip 127 between the first side support 121 and the second side support 124. This step 230 can involve creating the U-shaped cross-section of the hand grip 127 having the outer facing wall 130, the inner facing wall 132, and the bottom wall 134. The outer facing wall 130 of the hand grip 127 can be coupled to the outer walls 122, 125 and/or the inner walls 123, 126 of the first and second side supports 121, 124. The inner facing wall 132 and the bottom wall 134 of the hand grip 127 can be coupled to the inner walls 123, 126 of the first and second side supports 121, 124.

The method 200 can also include forming one of the apertures 136 in the bottom wall 134 of the hand grip 127 and the non-slip feature 140 in the outer facing wall 130 of the hand grip 127.

In accordance with further embodiments of the present disclosure, the receptacle 100 can include one or more vertical recessed portions 146 formed in the sidewall 114 that extend from adjacent the rim 116 to the bottom panel 112. The vertical recessed portions 146 can be configured to integrate with the lift handle 120 system while maintaining the generally cylindrical configuration of the hollow body 110. The vertical recessed portions 146 can be positioned to align with the lift handle 120 components, with each recessed portion extending downwardly from the region where the first side support 121 and the second side support 124 are coupled to the sidewall 114. The width of each vertical recessed portion 146 can be approximately equal to the distance between the first outer wall 122 and the second outer wall 125 of the lift handle 120. The width of each vertical recessed portion 146 can be substantially the same along with height of the receptacle 100. This configuration can maintain the load distribution characteristics established by the lift handle 120 while creating vertical access channels that facilitate user engagement at multiple levels of the receptacle 100.

Adjacent the bottom panel 112, each vertical recessed portion 146 can house a hand grip 148. The hand grip 148 can include a grip recess 150 that extends into the sidewall 114 to provide secure manual engagement. The grip recess 150 can be defined by a pair of side walls 152, a grip wall 154, and a wall 156. A width of the grip recess 150, measured as the distance between the pair of grip side walls 152 or alternatively as the length of the rear grip wall 154, may be equal to or less than the width of the lift handle 120. The width of the grip recess can provide adequate finger clearance for manual engagement by the user while minimizing material removal from the bottom panel 112. The reduced cutout dimensions can preserve structural integrity at the junction between the bottom panel 112 and sidewall 114, thereby reducing the likelihood for the receptacle 100 to tip during use.

The grip recess 150 can include a grip element 158 disposed between the grip side walls 152 and extending substantially across the width of the grip recess 150. The grip element 158 can be positioned at a predetermined height from the top wall 156 and spaced apart from the rear grip wall 154 by a specified distance to create an engagement zone for user contact. The spacing between the grip element 158 and the rear grip wall 154, combined with the height clearance from the top wall 156, can provide adequate finger accommodation and gripping surface area for secure manual engagement during handling operations. The grip element 158 can include contoured transitions 161 where it meets the grip side walls 152 to militate against stress concentration points and provide smooth load transfer between the grip element 158 and the side wall structure, thereby enhancing the structural integrity consistent with the load distribution principles established in the lift handle 120 system.

The grip element 158 can include a textured engagement surface configured to enhance user grip security during handling operations. The textured surface of the grip element 158 can be positioned to be generally flush with the exterior surface of the sidewall 114 within the vertical recessed portion 146, creating a continuous profile that maintains the structural continuity of the receptacle 100 while providing enhanced grip characteristics. This flush configuration can ensure that the grip element 158 integrates with the overall sidewall 114 design while providing the textured contact surface necessary for secure manual engagement during lifting and maneuvering operations.

In accordance with further embodiments of the present disclosure, the receptacle 100 can include a stabilization foothold 160 disposed centrally on the circumference of the bottom panel 112 between the hand grips 148. The foothold 160 can be positioned to work in conjunction with the vertical recessed portions 146 and hand grips 148 to create a comprehensive operational control system that extends the structural enhancement principles established throughout the receptacle 100. The foothold 160 can include a foothold recess 162 that projects into the sidewall 114, with the foothold recess 162 defined by a pair of foothold side walls 164, a rear foothold wall 166, and a foothold bottom wall 168. The foothold recess 162 can be configured to provide secure foot engagement during stabilization operations while maintaining the load distribution characteristics established by the lift handle 120 system. For example, secure foot engagement in the foothold recess can militate against the receptacle 100 from being lifted or knocked over when removing items therefrom, including when removing liners and trash bags from the receptacle 100.

The foothold bottom wall 168 can include sloped edges 170 located where the foothold bottom wall 168 meets the foothold side walls 164, creating increased structural thickness at these critical load-bearing zones. The sloped edges 170 can provide a tapered transition that distributes ground and foot reaction forces more effectively while militating against stress concentration points that could lead to structural failure. A reinforcing grid structure 172 can be integrated into the foothold bottom wall 168 to provide enhanced load-bearing capacity, with the reinforcing grid structure 172 including a plurality of intersecting support ribs that distribute applied loads across a broader contact area. The reinforcing grid structure 172 can include a variable rib density configuration, with the plurality of intersecting support ribs positioned at closer spacing intervals adjacent the sloped edges 170 compared to rib spacing in a central region of the foothold bottom wall 168. This concentrated rib pattern can provide enhanced structural reinforcement at the load transfer zones where the sloped edges 170 facilitate force distribution from the foothold bottom wall 168 to the foothold side walls 164, while optimizing material distribution throughout the reinforcing grid structure 172. The reinforcing grid structure 172 can include concentrated rib zones positioned adjacent the sloped edges 170, with the concentrated rib zones having closer rib spacing than central region ribs disposed in the central portion of the foothold bottom wall 168. This configuration can improve the structural durability of the foothold 160 compared to conventional designs while maintaining consistency with the enhanced durability principles that characterize the receptacle 100.

The plurality of intersecting support ribs can include a first set 178 of ribs and a second set 180 of ribs configured to optimize load transfer throughout the foothold structure. The first set 178 of ribs can have a curved configuration that corresponds to a curvature of the foothold side walls 164, following the natural stress patterns that develop during foot engagement. The second set 180 of ribs can extend substantially straight from edge regions of the foothold bottom wall toward a central region of the foothold bottom wall, creating radial load paths that channel forces from the perimeter toward the center of the foothold structure.

The first set 178 of ribs can be evenly spaced to provide consistent circumferential reinforcement, while the second set 180 of ribs can have variable spacing across the foothold bottom wall to optimize material placement where structural reinforcement is most needed. This variable spacing configuration allows for enhanced structural performance without unnecessary material usage, demonstrating the sophisticated engineering approach that characterizes the enhanced receptacle design. The dual spacing strategy ensures adequate reinforcement throughout the foothold while concentrating strength where applied loads are highest. Furthermore, the first set 178 of ribs and the second set 180 of ribs of the reinforcing grid structure 172 provide an open lattice on the bottom surface of the foothold bottom wall 168. The bottom surface of the foothold bottom wall 168 can be in contact with the ground or other support surface upon which the receptacle 100 rests. The open lattice can accommodate debris and materials and increase contact pressure between the ground and the edges of the first set 178 and the second set 180 of ribs to facilitate the leveling and stability of the receptacle 100 with respect to the ground.

The second set 180 of ribs can include concentrated spacing adjacent the sloped edges to provide enhanced structural reinforcement at critical load transfer zones. The concentrated rib zones can have closer rib spacing than the central regions, creating a variable density configuration that corresponds directly to the stress distribution patterns that develop during operational use. This concentration of reinforcement adjacent the sloped edges facilitates force distribution from the foothold bottom wall to the foothold side walls, ensuring that the highest stress areas receive appropriate structural support while maintaining material efficiency throughout the remainder of the foothold structure.

The combination of the curved first set of ribs with the straight second set of ribs, together with the variable density spacing pattern, creates an integrated reinforcement system that optimizes material distribution throughout the foothold. The curved ribs handle circumferential stresses that develop around the foothold perimeter, while the straight ribs provide radial load distribution that channels concentrated forces toward the center. The concentrated spacing adjacent the sloped edges ensures that the critical load transfer zones receive enhanced structural reinforcement where the sloped edges facilitate force distribution between the foothold bottom wall and the foothold side walls. This comprehensive reinforcement approach maintains the enhanced durability principles established throughout the receptacle while providing superior performance characteristics compared to conventional textured surface approaches.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A receptacle comprising:
a hollow body having a bottom panel and a sidewall extending upwardly from the bottom panel; and
a stabilization foothold disposed on a circumference of the bottom panel, the foothold including a foothold recess that projects into the sidewall, the foothold recess defined by foothold side walls, a rear foothold wall, and a foothold bottom wall having a sloped edge at a junction where the foothold bottom wall meets the foothold side walls.

2. The receptacle of claim 1, wherein the foothold bottom wall includes a first sloped edge and a second sloped edge, the first sloped edge located at a junction with a first foothold side wall and the second sloped edge located at a junction with a second foothold side wall.

3. The receptacle of claim 2, wherein the foothold bottom wall includes a reinforcing grid structure integrated therein.

4. The receptacle of claim 3, wherein the reinforcing grid structure includes a plurality of intersecting support ribs that distribute applied loads across a contact area of the foothold bottom wall.

5. The receptacle of claim 4, wherein the reinforcing grid structure includes concentrated rib zones positioned adjacent the sloped edges.

6. The receptacle of claim 4, wherein the plurality of intersecting support ribs include a first set of ribs extending in a first direction and a second set of ribs extending in a second direction perpendicular to the first direction.

7. The receptacle of claim 4, wherein the plurality of intersecting support ribs include a first set of ribs having a curved configuration that corresponds to a curvature of the foothold sidewalls.

8. The receptacle of claim 7, wherein the plurality of intersecting support ribs include a second set of ribs extending substantially straight from edge regions of the foothold bottom wall toward a central region of the foothold bottom wall.

9. The receptacle of claim 8, wherein the first set of ribs are evenly spaced and the second set of ribs have variable spacing across the foothold bottom wall.

10. The receptacle of claim 9, wherein the second set of ribs include concentrated spacing adjacent the sloped edges to provide enhanced structural reinforcement at critical load transfer zones.

11. The receptacle of claim 1, further comprising a hand grip positioned on the circumference of the bottom panel.

12. The receptacle of claim 11, comprising two hand grips disposed on opposite sides of the receptacle.

13. The receptacle of claim 12, wherein the stabilization foothold is positioned centrally between the two hand grips on the circumference of the bottom panel.

14. The receptacle of claim 13, wherein the foothold bottom wall includes a reinforcing grid structure integrated therein, the reinforcing grid structure having a plurality of intersecting support ribs.

15. The receptacle of claim 14, wherein the plurality of intersecting support ribs includes a first set of ribs extending in a first direction and a second set of ribs extending in a second direction perpendicular to the first direction.

16. The receptacle of claim 14, wherein the plurality of intersecting support ribs include a first set of ribs having a curved configuration that corresponds to a curvature of the foothold side walls and a second set of ribs extending substantially straight from edge regions of the foothold bottom wall toward a central region of the foothold bottom wall.

17. The receptacle of claim 1, further comprising a lift handle formed on the sidewall wherein the lift handle includes a first side support and a second side support spaced apart from the first side support.

18. The receptacle of claim 17, wherein the first side support includes a first outer wall and a first inner wall, the first outer wall spaced apart from the first inner wall and coupled to the sidewall of the hollow body, and wherein the second side support includes a second outer wall and a second inner wall, the second outer wall spaced apart from the second inner wall and coupled to the sidewall of the hollow body.

19. The receptacle of claim 18, wherein the lift handle includes a first connecting wall joining the first outer wall and the first inner wall of the first side support and a second connecting wall joining the second outer wall and the second inner wall of the second side support.

20. The receptacle of claim 18, wherein the lift handle includes a hand grip disposed between the first inner wall of the first side support and the second inner wall of the second side support, the hand grip including an outer facing wall, an inner facing wall, and a bottom wall forming a generally U-shaped cross-section.
